(19) United States
(12) Patent Application Publication
(10) Pub. No.: US 2006/0044710 A1
(43) Pub. Date: Mar. 2, 2006

(54) Ground fault detector for generator feeder

(76) Inventors: Bruce D. Beneditz, Roscoe, IL (US); Donal E. Baker, Rockford, IL (US); Wayne H. Oldenburg, Roscoe, IL (US); John F. Defenbaugh, Rockford, IL (US); Massoud Vaziri, Bellevue, WA (US)

Correspondence Address: CARLSON, GASKEY & OLDS, P.C., 400 WEST MAPLE ROAD, SUITE 350, BIRMINGHAM, MI, 48009, US

(21) Appl. No.: 10/925,056

(22) Filed: Aug. 24, 2004

(51) Int. Cl. H02H 7/06

(52) U.S. Cl. 361/20

(57) ABSTRACT

A generator feeder fault detection system includes a ground fault detector transformer that monitors the sum of forward and return currents from and to a generator. During normal operation, the sum of the currents in the ground fault detector equals zero. If there is a fault, however, the ground fault detector will detect a non-zero current sum. Because the ground fault detector measures the sum of the currents traveling through it, the current sensor in the detection circuit can be selected to measure small amounts of current and does not need to have a high threshold, even for generators that output high levels of current.

### TECHNICAL FIELD

The present invention relates to aircraft generator feeders, and more particularly to a circuit that detects a ground fault in an aircraft generator feeder.

### BACKGROUND OF THE INVENTION

Generator feeders are commonly used in aircraft electric power generating systems to supply power to the aircraft. Generator feeders link a generator with an aircraft power panel to supply current to the power panel. The generator feeder may experience a ground fault if, for example, there is a break in wire insulation or a faulty connector. The ground fault will cause current to leak from the generator feeder to other areas in the aircraft.

Differential protection circuits are normally used to detect these faults by measuring the difference between the current supplied by the generator and the current consumed by the aircraft system through the power panel. The differential protection circuit de-excites the generator and trips one or more generator circuit breakers in the power panel if it detects a fault current above a selected threshold, indicating that a large amount of current supplied by the generator is not arriving at the power panel.

Because airframes in the aircraft are commonly manufactured from aluminum, which is highly conductive, fault currents leaking from the generator feeders will immediately travel through the aircraft. The airframe therefore acts as an effective ground for the fault current. The fault current threshold for the differential protection circuit in this case is normally set to a moderately high level (e.g., around 30 A) because the aluminum in the airframe can easily conduct these amounts of current away from the fault without heating or any other adverse effects. Thus, it is not necessary to detect faults below this level. Moreover, the highly conductive properties of aluminum causes fault currents to be immediately conducted away from the power panel to ground and create a high current differential easily detectable by the differential protection circuit.

In more recent airframe structures, composite materials, such as carbon graphite fiber, are becoming increasingly common. Unlike aluminum, composite materials tend to act as a resistive heating element rather than as a conductor. As a result, they are not as effective as aluminum airframes in grounding fault currents. For some composites, fault currents as low as 5 A over a long period of time may cause structural degradation. Thus, it is desirable to detect even small fault currents to ensure optimum airframe conditions.

Fault currents at this low level, however, are particularly hard to detect because they are well below the current detection threshold of the differential protection circuit. Traditional differential protection circuits suffer from inaccuracies due to the inherent tolerances in current measurement devices and the independent measurement of the current leaving the generator and the current entering the power panel. Any current sensor employed in this case to detect a low level of fault current must also be able to detect the high fault currents (i.e., on the order of thousands of amperes) that occur if the feeder fault generates a short circuit condition. However, current sensors are designed for optimum measurement in a limited range; thus, for example, a sensor that can accurately measure small fault currents will have a differential protection threshold that is too low to handle high fault currents, while a sensor having a high differential protection threshold will not be able to measure small fault currents accurately. Also, the composite airframe acts as a resistive load with no arcing characteristics that would be detectable using signal processing techniques.

There is a desire for a generator feeder fault detector that can reliably detect small fault currents so that it can be used in an aircraft having a composite airframe.

### SUMMARY OF THE INVENTION

The present invention is directed to a generator feeder fault detection system that can detect even small fault currents accurately. The system includes a ground fault detection senor that monitors the sum of the currents leaving a generator to a power panel and returning from the power panel back to the generator. During normal operation, the sum of the currents in the ground fault detection current transformer equals zero. If there is a fault, however, the ground fault detection circuit will detect a current sum greater than zero.

Because the ground fault detector measures the sum of the currents traveling through it, the current sensor in the ground fault detector can be selected to measure small amounts of current and does not need to have a high threshold, even for generators that output high levels of current.

### BRIEF DESCRIPTION OF THE DRAWINGS

FIG. 1 is a representative diagram of a system containing generator feeders and a generator feeder fault detector according to one embodiment of the invention;

FIG. 2 is a representative diagram of a system with a generator feeder fault detector according to another embodiment of the invention; and

FIG. 3 is a representative diagram of a generator control unit having a generator feeder fault detector according to another embodiment of the invention.

### DETAILED DESCRIPTION OF THE PREFERRED EMBODIMENT

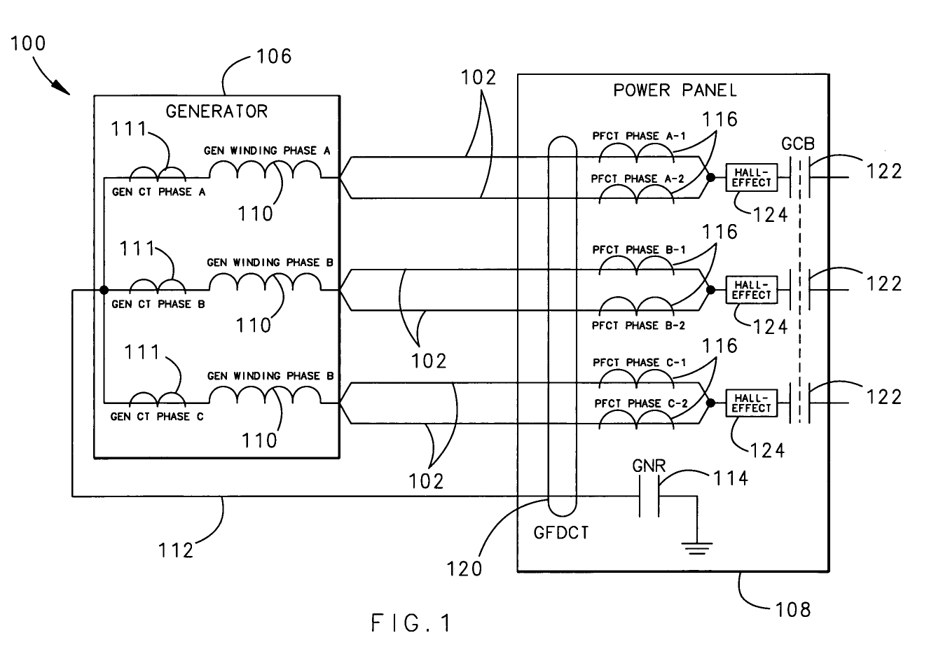

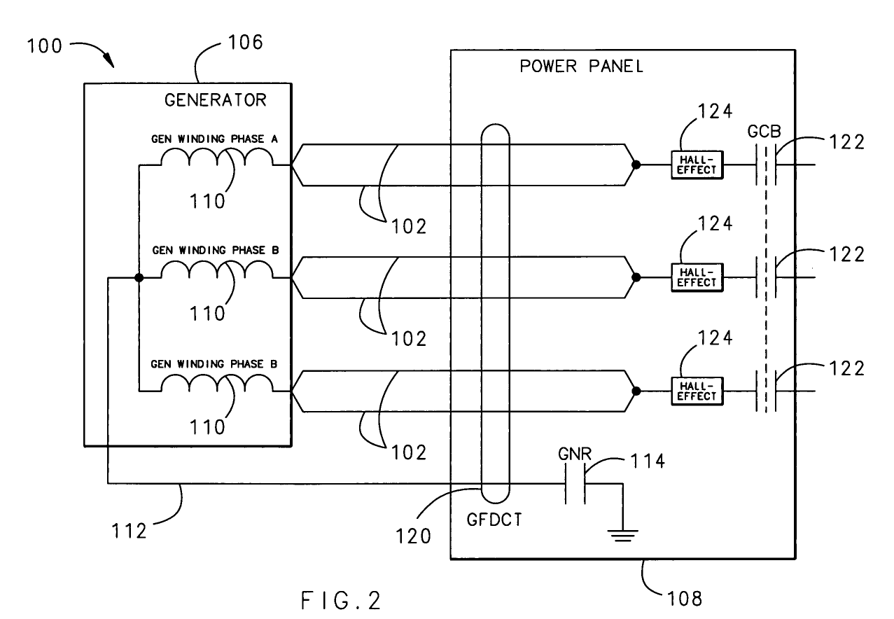

The invention is generally directed to a generator feeder system 100 having a fault detector that can detect even small fault currents in a generator feeder 102 accurately. As shown in FIGS. 1 and 2, a given system 100 may include a generator 106 and a power panel 108 linked by a plurality of feeders 102. In the illustrated embodiment, the generator 106 is a three-phase generator having a phase winding 110 associated with each phase. The feeders 102 may be single or parallel feeders that share the generator load. The generator neutral connection 112 is connected to a ground of the aircraft through a generator neutral connection relay (GNR) 114 in the power panel 108. The generator neutral connection 112 carries any unbalanced load current back to the generator.

Each phase winding 110 has an associated generator current transformer 111 for over-current protection of the generator 106 and the feeders 102. As is known in the art, a feeder fault will typically cause the generator 106 to feed more current than it should feed. The generator current transformers 111 cause the generator 106 to shut off if the fault continues for an extended time period.

The power panel 108 may also include parallel feeder current transformers (PFCT) 116. The PFCTs 116 measure the current in each feeder 102 to ensure that the current is at a level that does not indicate an open feeder 102. In the example shown in FIG. 1, each phase winding 110 in the generator 106 has two associated PFCTs 116. For each phase, the difference between the current in the generator current transformers 111 and the sum of the current in the PFCTs 116 for that phase is the current differential normally used to detect feeder faults. As a result, the generator current transformers 111 and the PFCTs 116 in combination are used for differential protection.

Fault detection is performed by a ground fault detector 120, such as a ground fault detection current transformer, in the power panel 108. The generator neutral connection 112 and the GNR 114 make using the ground fault detector 120 possible because the grounding for the system 100 centralizes the ground of the system 100 to a specific location that can include the feeders 102 and the generator neutral connection 112 in the ground fault detector 120.

The ground fault detector 120 monitors the sum of the currents on the feeders 102 and the generator neutral connection 112. The forward and return currents on the feeders 102 travel in opposite directions, and therefore the sum of the forward and return currents traveling through the ground fault detector 120 will equal zero if there are no faults causing current leakage in any of the feeders 102. If there is a feeder fault, however, the sum of the currents through the ground fault detector 120 will be non-zero because current leakage will cause the forward and return currents to be unequal.

Because the ground fault detector 120 monitors the sum of the currents in the system 100 rather than the absolute value of the individual currents, it can detect very small fault currents while still allowing high currents to flow normally. Even a tiny fault in the feeder 102 will be detectable by the ground fault detector 120 because the current sum will normally be zero and therefore any non-zero sum in the ground fault detector 120 will be registered as a fault. Thus, the ground fault detector 120 does not need to have a high threshold, even for generators 106 that output high levels of current. Instead, the components in the ground fault detector 120 can be designed to measure small amounts of current. If a ground fault occurs, the resulting current difference de-excites the generator 106 and trips a generator circuit breaker 122 to stop current flow in the feeders 102.

Hall Effect sensors 124 may also be included in the power panel 108. The Hall Effect sensors 124 are able to sense both DC and AC current in the feeders 102. The Hall effect sensors 124 act as a supplemental protection device to handle faults causing high DC currents to pass through the feeders 102. As is known in the art, faults that cause over-currents with significant DC content (e.g., rectified load faults) will saturate the PFCTs 116, which are AC devices, and cause them to stop working. When they are saturated, however, they will indicate that there is no current passing through even though DC current is passing through both the PFCTs 116 and the generator current transformers 111. As a result, the current differential between the PFCTs 116, the generator current transformers 111, and the ground fault detector 120 will not indicate the presence of a fault. The Hall Effect sensors 124 are used to ensure that DC load faults will still be detectable.

Regardless of the specific fault, a generator circuit breaker 122 is tripped by either the Hall Effect sensor 124 or the ground fault detector 120 to stop current flow in the feeders 102 if a fault is detected.

Note that the generator current transformers 111 may be eliminated from this embodiment without any adverse effect. Traditionally, the generator current transformers 111 are also used to limit generator power in load faults, such as line-to-line faults between the feeders 102, which result in severe current imbalances between pairs of PFCTs 116 in a given phase (FIG. 1). The PFCTs 116 can serve the power limiting function instead because the generator feeders 102 are protected by the ground fault detector 120. This greatly reduces the number of components and wires in the system 100.

FIG. 2 illustrates another embodiment of the inventive system 100. This embodiment does not have any generator current transformers 111 or PFCTs 116 because the ground fault detector 120 can detect all probable feeder faults. The Hall Effect sensors 124 are still incorporated in this embodiment to detect and protect against both overcurrent faults and DC load faults. In this example, each phase has two Hall Effect sensors 124 to conduct open feeder protection in addition to overcurrent and DC load fault protection. The Hall Effect sensors 124 in essence replace the PFCTs 116 shown in the previous embodiment.

As explained above, the ground fault detector 120 de-excites the generator 106 and trips the generator circuit breaker 122 as there is a significant difference in the current on the feeders 102. Incorporating the ground fault detector 120 into the system 100 therefore allows the generator current transformers to be eliminated from the generator 106 and the PFCTs 116 to be eliminated from the system 100 because differential current detection is no longer an issue. Thus, the embodiment shown in FIG. 2 provides fault detection without requiring any current transformers other than the one, if used, for the ground fault detector 120.

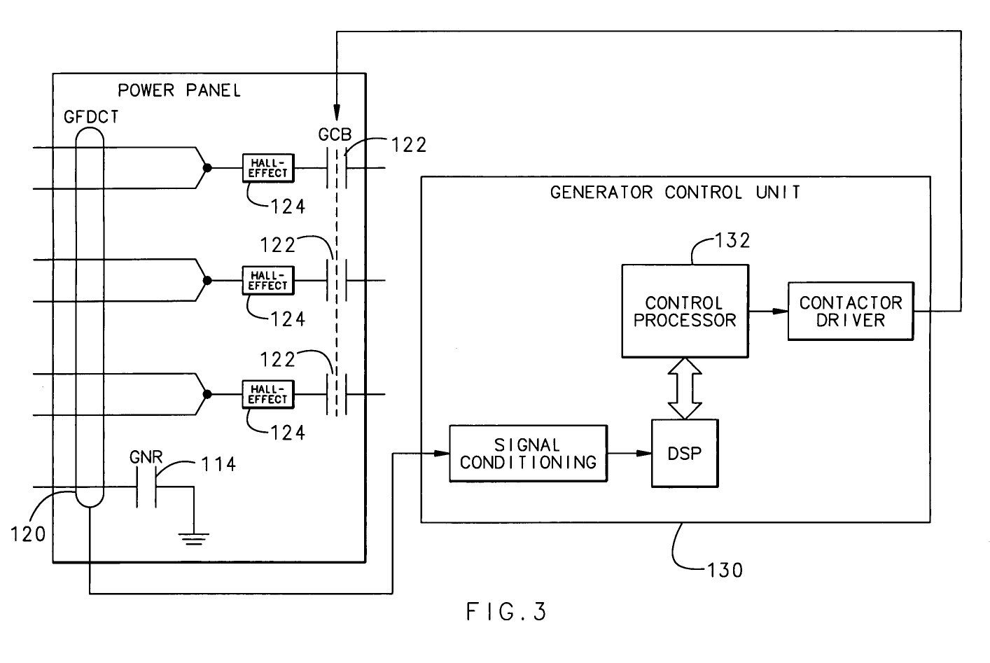

The system 100 shown in FIGS. 1 and 2 may be used in a generator control unit 130, as shown in FIG. 3, having a control processor 132 that processes the non-zero fault current signal detected by the ground fault detector 120 to identify and protect against intermittent faults to ground by detecting the signature of an arc in the measured ground fault current. The location of the ground fault detector 120 ensures that it will always see the true power level of the generator 106 and will not be affected by unbalanced loads or non-linear loads in the aircraft.

In one example, the generator 106 is also used as a motor to start an aircraft engine (not shown). In the starter mode, the generator is used as a three-phase motor. In this mode the generator neutral connection 112 is disconnected by opening the GNR 114 The operation of the GNR 114 may be controlled by the generator control unit in coordination with the engine start electrical power source.

To prevent undetected dormant faults caused by failure of the ground fault detector 120 and/or the system 100 described above may require a built-in-test (BIT). The BIT may be conducted by connecting a small known load in the power panel 108 to appear as a differential fault. The fixed error induced by this load will be ignored by the ground fault protection circuit in the ground control unit. However, if the error goes to zero then it can be assumed that the ground fault detector has failed.

Using a ground fault detector in an aircraft as a feeder fault detector therefore allows easy detection of even small feeder faults by acting as one large central current transformer connected to the feeders and the neutral line. Under all normal operating conditions, the sum of the currents through the ground fault detector will be zero; thus, any non-zero current sum will indicate a fault. The ground fault detector also simplifies DC current fault protection by eliminating the need for coordination between DC fault detectors (e.g., Hall effect sensors) and any differential protection circuitry, such as generator current transformers and PFCTs. Moreover, as shown in FIG. 2, the number of components in the overall system may be reduced because PFCTs can be replaced completely with Hall Effect sensors.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A generator feeder system, comprising:
a generator having a plurality of generator windings;
a generator neutral connection connected to at least one of said plurality of generating windings and to ground;
a power panel;
at least one feeder connected the generator and the power panel; and
a ground fault detector coupled to the generator neutral connection and said at least one feeder, wherein the ground fault detector indicates a fault if a sum of currents through said at least one feeder and the generator neutral connection is non-zero.

2. The generator feeder system of claim 1, wherein said at least one feeder comprises a plurality of parallel feeders.

3. The generator feeder system of claim 1, wherein said at least one feeder comprises a plurality of single feeders.

4. The generator feeder system of claim 3, wherein each of said plurality of generator windings has two associated feeders.

5. The generator feeder system of claim 1, further comprising a generator neutral relay connected between the generator neutral connection and ground.

6. The generator feeder system of claim 1, further comprising at least one generator circuit breaker coupled to the ground fault detector, wherein the generator circuit breaker trips when the ground fault detector indicates a fault to stop current flow in said at least one feeder.

7. The generator system of claim 1, further comprising at least one Hall Effect sensor disposed on said at least one feeder.

8. A generator feeder system, comprising:
a generator having a plurality of generator windings corresponding to a plurality of phases;
a generator neutral connection connected to at least one of said plurality of generating windings and to ground;
a power panel;
a plurality of feeders connected between the power panel and the generator, wherein each winding has two associated feeders connected to it;
a ground fault detector coupled to the generator neutral connection and said at least one feeder, wherein the ground fault detector indicates a fault if a sum of currents through said plurality of feeders and the generator neutral connection is non-zero; and
at least one generator circuit breaker coupled to the ground fault detector, wherein the generator circuit breaker trips when the ground fault detector indicates a fault to stop current flow in said at least one feeder.

9. The generator feeder system of claim 8, further comprising a generator neutral relay connected between the generator neutral connection and ground.

10. The generator feeder system of claim 8, further comprising at least one Hall Effect sensor disposed on said at least one feeder.

11. The generator feeder system of claim 8, further comprising at least one feeder current transformer disposed on at least one of said plurality of feeders.

12. The generator feeder system of claim 8, further comprising a generator control unit that processes the fault indication from the ground fault detector.

13. The generator feeder system of claim 8, wherein the generator control unit processes the fault indication by detecting an arc signature to protect against intermittent faults.
